(19) United States
(12) Patent Application Publication
(10) Pub. No.: US 2025/0321919 A1
(43) Pub. Date: Oct. 16, 2025

(54) COMMUNICATION APPARATUS, COMMUNICATION METHOD, AND RECORDING MEDIUM

(71) Applicant: Yusuke UGAJIN, Kanagawa (JP)

(72) Inventor: Yusuke UGAJIN, Kanagawa (JP)

(21) Appl. No.: 19/173,819

(22) Filed: Apr. 9, 2025

(30) Foreign Application Priority Data
Apr. 11, 2024 (JP) 2024-063902

(51) Int. Cl. G06F 13/42; G06F 13/40

(52) U.S. Cl. CPC G06F 13/4282; G06F 13/4072

(57) ABSTRACT

A communication apparatus that operates in a plurality of operation modes with different power consumptions includes a main system, a subsystem, a communication module, a first bus, a second bus, a bus switch, and a bus switching control circuit. The communication module communicates with an external apparatus. The first bus connects the main system and the communication module to each other to allow the main system to control the communication module. The second bus connects the subsystem and the communication module to each other to allow the subsystem to control the communication module. The bus switch switches between two connection states. The bus switching control circuit controls the bus switch to switch between the two states according to an operation mode set in the communication apparatus among the plurality of operation modes.

### CROSS-REFERENCE TO RELATED APPLICATIONS

This patent application is based on and claims priority pursuant to 35 U.S.C. § 119 (a) to Japanese Patent Application No. 2024-063902, filed on Apr. 11, 2024, in the Japan Patent Office, the entire disclosure of which is hereby incorporated by reference herein.

### BACKGROUND

### Technical Field

Embodiments of the present disclosure relate to a communication apparatus, a communication method, and a recording medium.

### Related Art

There is a technique for selectively executing a normal mode and a power-saving mode during wireless local area network (LAN) communication to consume less power in the power-saving mode than in the normal mode. In the normal mode, a main system and a subsystem operate. In the power-saving mode, the subsystem operates and the main system stops. There is also a technique for determining whether or not a data frame received from a wireless LAN module is specific to wireless communication and then determining whether or not the data frame is to be processed by the main system or the subsystem, regardless of whether in the normal mode or the power-saving mode.

### SUMMARY

According to an embodiment of the present disclosure, a communication apparatus that operates in a plurality of operation modes with different power consumptions includes a main system, a subsystem, a communication module, a first bus, a second bus, a bus switch, and a bus switching control circuit. The communication module communicates with an external apparatus external to the communication apparatus. The first bus connects the main system and the communication module to each other to allow the main system to control the communication module. The second bus connects the subsystem and the communication module to each other to allow the subsystem to control the communication module. The bus switch switches between two states. One of the two states is a state in which the main system and the communication module are communicably connected to each other via the first bus. Another one of the two states is a state in which the subsystem and the communication module are communicably connected to each other via the second bus. The bus switching control circuit controls the bus switch to switch between the two states according to an operation mode set in the communication apparatus among the plurality of operation modes.

According to an embodiment of the present disclosure, a communication method executed by a communication apparatus that includes a main system and a subsystem and operates in a plurality of operation modes with different power consumptions includes connecting the main system and a communication module to each other via a first bus to allow the main system to control the communication module, the communication module being a communication module to communicate with an external apparatus external to the communication apparatus, connecting the subsystem and the communication module to each other via a second bus to allow the subsystem to control the communication module, and controlling a bus switch to switch between two states according to an operation mode set in the communication apparatus among the plurality of operation modes, one of the two states being a state in which the main system and the communication module are communicably connected to each other via the first bus, another one of the two states being a state in which the subsystem and the communication module are communicably connected to each other via the second bus.

According to an embodiment of the present disclosure, a non-transitory recording medium stores a plurality of instructions which, when executed by one or more processors on a communication apparatus, causes the processors to perform a communication method. The communication apparatus includes a main system and a subsystem and configured to operate in a plurality of operation modes with different power consumptions. The communication method includes connecting the main system and a communication module to each other via a first bus to allow the main system to control the communication module, the communication module being a communication module to communicate with an external apparatus external to the communication apparatus, connecting the subsystem and the communication module to each other via a second bus to allow the subsystem to control the communication module, and controlling a bus switch to switch between two states according to an operation mode set in the communication apparatus among the plurality of operation modes, one of the two states being a state in which the main system and the communication module are communicably connected to each other via the first bus, another one of the two states being a state in which the subsystem and the communication module are communicably connected to each other via the second bus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a block diagram illustrating an example of a hardware configuration of a communication apparatus according to first and second embodiments;

FIG. 2 is a block diagram illustrating an example of a functional configuration of the communication apparatus according to the first and second embodiments;

FIG. 3 is a block diagram schematically illustrating a configuration of a data communication system including a bus switching control device according to the first embodiment;

FIG. 4 is a sequence diagram illustrating the operation of the communication apparatus in each operation mode according to the first embodiment;

FIGS. 5A and 5B are flowcharts illustrating the operation of a subsystem in different operation modes of the communication apparatus according to the first embodiment;

FIGS. 6A and 6B are diagrams illustrating flows of data communication of the communication apparatus according to the first embodiment in different operation modes; and

FIG. 7 is a flowchart illustrating an example of the processing of the communication apparatus according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described in detail below with reference to the drawings.

### Example of Configuration of Communication Apparatus

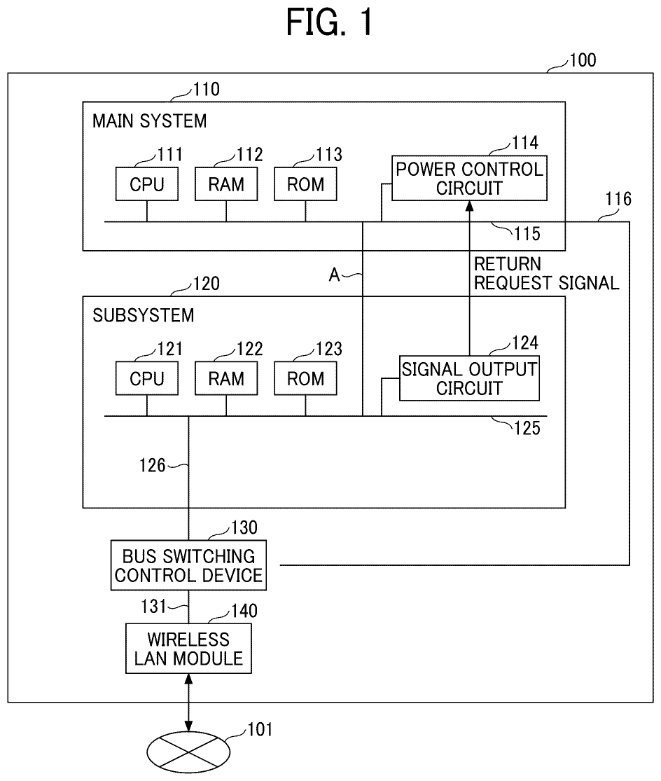

FIG. 1 is a block diagram illustrating an example of a hardware configuration of a communication apparatus 100 according to first and second embodiments.

The communication apparatus 100 according to the first and second embodiments is, for example, a personal computer (PC) or an image forming apparatus with functions such as a printer, a scanner, a copier, and a facsimile (fax). Examples of the image forming apparatus include a multifunction peripheral. The communication apparatus 100 is connected to a network 101, which includes, for example, a wireless local area network (LAN). The communication apparatus 100 may be, for example, a projector (PJ), an interactive white board (IWB), which is an electronic whiteboard that performs interactive communication, an output apparatus such as a digital signage, or a head-up display (HUD). Alternatively, the communication apparatus 100 may be, for example, an industrial machine, an imaging apparatus, a sound collection apparatus, a medical apparatus, a network home appliance, or an automobile (connected car). Alternatively, the communication apparatus 100 may be, for example, a laptop computer (personal computer), a mobile phone, a smartphone, a tablet terminal, a game console, a personal digital assistant (PDA), a digital camera, a wearable PC, or a desktop PC.

The communication apparatus 100 includes, for example, a main system 110, a subsystem 120, a bus switching control device 130, and a wireless LAN module 140. The main system 110 and the subsystem 120, which are included in the communication apparatus 100, are connected to each other via a bus A. A bus may also be referred to as a transmission path or a communication path. In the following examples, the communication apparatus 100 includes the wireless LAN module 140, which is an example of a communication module. In another example, the communication apparatus 100 may include another wireless communication module or a wired communication module as the communication module.

The communication apparatus 100 operates in a plurality of operation states with different power consumptions. In the following description, an operation state may also be referred to as an operation mode. Specifically, the communication apparatus 100 operates in a plurality of operation modes with different power consumptions.

Examples of the plurality of operation modes include a normal mode and a power-saving mode. When the communication apparatus 100 operates in the normal mode, the main system 110 and the subsystem 120 operate. In the normal mode, the communication apparatus 100 executes functions included in the communication apparatus 100 under the control of the main system 110. When the communication apparatus 100 operates in the power-saving mode, the main system 110 stops and the subsystem 120 operates.

The main system 110 has a higher information processing capacity than the subsystem 120. However, the main system 110 consumes more power than the subsystem 120. In other words, the communication apparatus 100 consumes much less power in the power-saving mode than in the normal mode.

In the following description, the activation of the main system 110 or the subsystem 120 may be referred to as the operation of the main system 110 or the subsystem 120. In other words, the activation of the main system 110 or the subsystem 120 may be synonymous with the operation of the main system 110 or the subsystem 120.

### Hardware Configuration of Main System

The main system 110 includes, for example, a central processing unit (CPU) 111, a random-access memory (RAM) 112, a read-only memory (ROM) 113, a power control circuit 114, an internal bus 115, and a main wireless LAN module control bus 116.

For example, the CPU 111 functions as a processing device and a control device and controls the operation of the main system 110 according to various programs.

The RAM 112 temporarily stores programs that are executed by the CPU 111 and parameters that may be changed when the programs are executed.

The ROM 113 stores, for example, programs and computing parameters used by the CPU 111. The ROM 113 also stores information used in authentication processing. Examples of the information used in the authentication processing include authentication methods relating to communication through a wireless LAN, electronic certificates conforming to X.509, such as certification authority (CA) certificates and client certificates, and passphrases.

The power control circuit 114 controls the power supply to the main system 110. For example, when the communication apparatus 100 shifts to the power-saving mode, the power control circuit 114 stops supplying power to the main system 110. When the power control circuit 114 receives, from the subsystem 120, a return request signal requesting a return to the normal mode while the communication apparatus 100 is in the power-saving mode, the power control circuit 114 resumes supplying power to the main system 110. Even when the communication apparatus 100 is in the power-saving mode, power is constantly supplied to the power control circuit 114.

The CPU 111, the RAM 112, the ROM 113, and the power control circuit 114 are connected to each other via the internal bus 115 to transmit, for example, address signals, data signals, and various control signals.

The main wireless LAN module control bus 116, which is an example of a first bus, connects the main system 110 and the bus switching control device 130 to each other. When the main system 110 is connected to the bus switching control device 130, the main system 110 controls the wireless LAN module 140.

### Hardware Configuration of Subsystem

The subsystem 120 includes, for example, a CPU 121, a RAM 122, a ROM 123, a signal output circuit 124, an internal bus 125, and a wireless LAN module connection bus 126.

For example, the CPU 121 functions as a processing device and a control device and controls the operation of the subsystem 120 according to various programs. The CPU 121 has a lower information processing capacity than the CPU 111.

The RAM 122 temporarily stores programs that are executed by the CPU 121 and parameters that may be changed when the programs are executed.

The ROM 123 stores, for example, programs and computing parameters used by the CPU 121.

The signal output circuit 124 is a circuit that outputs, to the main system 110, a return request signal requesting a return from the power-saving mode, under the control of the CPU 121.

The CPU 121, the RAM 122, the ROM 123, and the signal output circuit 124 are connected to each other via the internal bus 125.

The wireless LAN module connection bus 126, which is an example of a second bus, connects the subsystem 120 and the bus switching control device 130 to each other. When the subsystem 120 is connected to the bus switching control device 130, the subsystem 120 controls the wireless LAN module 140.

The bus switching control device 130 connects the main wireless LAN module control bus 116 and a wireless LAN module control bus 131 to each other, thereby connecting the main system 110 and the wireless LAN module 140 to each other so as to enable (or establish) communication therebetween. The bus switching control device 130 connects the wireless LAN module connection bus 126 and the wireless LAN module control bus 131 to each other, thereby connecting the subsystem 120 and the wireless LAN module 140 to each other so as to enable (establish) communication therebetween.

Specifically, the bus switching control device 130 switches the destination to which the wireless LAN module 140 is connected from the main system 110 to the subsystem 120. Further, the bus switching control device 130 switches the destination to which the wireless LAN module 140 is connected from the subsystem 120 to the main system 110.

The bus switching control device 130 also communicates with the wireless LAN module 140 via the wireless LAN module control bus 131. The communication speed of the main wireless LAN module control bus 116, the wireless LAN module connection bus 126, and the wireless LAN module control bus 131 depends on the CPU 111 or the CPU 121, which is the host that controls the wireless LAN communication.

The wireless LAN module 140, which is an example of the communication module, is connected to the main system 110 via the wireless LAN module control bus 131 and the bus switching control device 130, and further via the main wireless LAN module control bus 116 and the internal bus 115 of the main system 110. Further, the wireless LAN module 140 is connected to the subsystem 120 via the wireless LAN module control bus 131 and the bus switching control device 130, and further via the wireless LAN module connection bus 126 and the internal bus 125 of the subsystem 120. The wireless LAN module 140 is an interface for connecting the communication apparatus 100 to the network 101, which includes, for example, a wireless LAN.

The network 101, which includes, for example, a wireless LAN, may be provided by an external apparatus that is different from the communication apparatus 100. In other words, communication between the wireless LAN module 140 and the network 101 may be synonymous with communication between the wireless LAN module 140 and the external apparatus.

In the following description, the wireless LAN module 140 may be referred to as the communication module.

The wireless LAN module 140 may be disposed separately from the main system 110 and the subsystem 120, as illustrated in FIG. 1. Alternatively, the main system 110 or the subsystem 120 may include the wireless LAN module 140.

### Functional Configuration

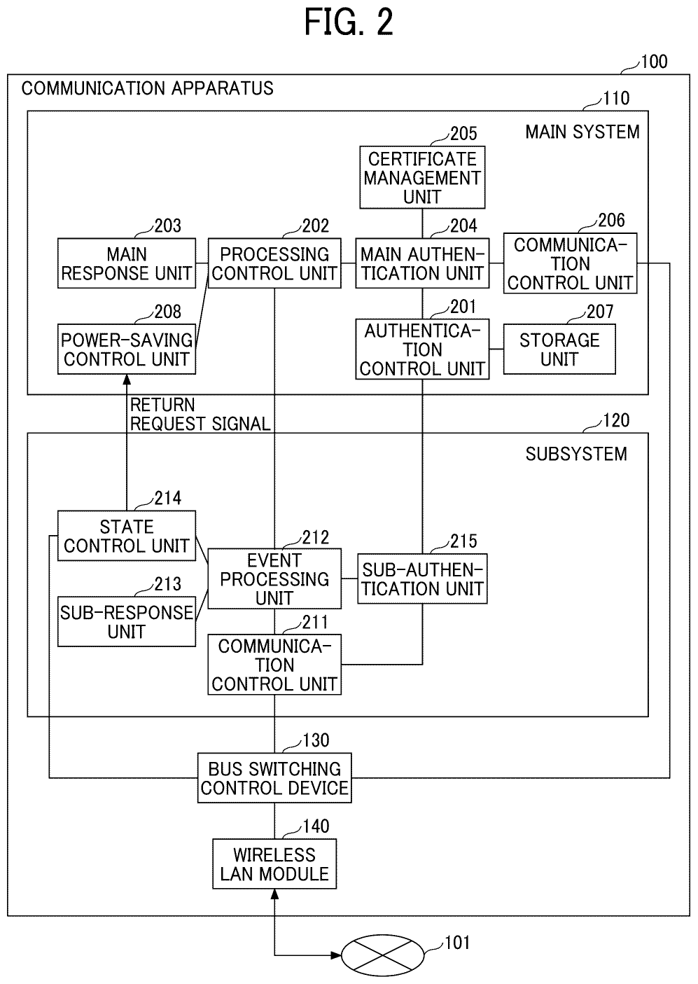

FIG. 2 is a block diagram illustrating an example of a functional configuration of the communication apparatus 100 according to the first and second embodiments.

The communication apparatus 100 includes the main system 110, which executes first authentication processing, and the subsystem 120, which executes second authentication processing. The first authentication processing is authentication processing using an authentication method in which processing relating to an electronic certificate is executed. Examples of the authentication method in which the processing relating to an electronic certificate is executed include Wi-Fi protected access (WPA)-Enterprise authentication. The second authentication processing is authentication processing using an authentication method in which the processing relating to an electronic certificate is not executed. Examples of the authentication method in which the processing relating to an electronic certificate is not executed include open authentication or Wi-Fi protected access 2 pre-shared key (WPA2-PSK) authentication.

### Functional Configuration of Main System

The main system 110 includes, for example, an authentication control unit 201, a processing control unit 202, a main response unit 203, a main authentication unit 204, a certificate management unit 205, a communication control unit 206, a storage unit 207, and a power-saving control unit 208, each of which is implemented by the CPU 111 reading and executing predetermined programs stored in the RAM 112 and the ROM 113. At least part of the above-described functional units may be implemented by hardware. The predetermined programs may be stored in the ROM 123 of the subsystem 120 or may be separately stored in the ROM 113 of the main system 110 and the ROM 123 of the subsystem 120.

The authentication control unit 201 causes the main system 110 or the subsystem 120 to execute authentication processing for participating in (or connecting to) the network 101. For example, the authentication control unit 201 causes the main authentication unit 204 or a sub-authentication unit 215 of the subsystem 120 to execute processing for connecting to an access point depending on an authentication method stored in the RAM 112 and the ROM 113 and set in the communication apparatus 100. For example, when the authentication method stored in the storage unit 207 is the authentication method in which the processing relating to an electronic certificate is not executed, the authentication control unit 201 causes the subsystem 120 to execute the authentication processing for participating in the network 101. When the authentication method stored in the RAM 112 and the ROM 113 is the authentication method in which the processing relating to an electronic certificate is executed, the authentication control unit 201 causes the main system 110 to execute the authentication processing for connecting to the network 101.

The processing control unit 202 causes a processing unit corresponding to a data frame received from an event processing unit 212 of the subsystem 120 to execute the data frame. For example, when the received data frame is a data frame relating to the authentication processing, the processing control unit 202 transfers the data frame to the main authentication unit 204. When the received data frame is not a data frame relating to the authentication processing, the processing control unit 202 transfers the data frame to the main response unit 203.

When the processing control unit 202 receives, from the main authentication unit 204 or the main response unit 203, a response frame as a response to the transferred data frame, the processing control unit 202 transfers the response frame to the event processing unit 212.

The main response unit 203 creates a response frame as a response to the data frame received from the processing control unit 202 and outputs the created response frame to the processing control unit 202.

The main authentication unit 204 executes the first authentication processing using the authentication method such as WPA-Enterprise authentication in which the processing relating to an electronic certificate is executed. For example, the main authentication unit 204 controls the wireless LAN module 140 via the bus switching control device 130 using the communication control unit 206 to execute processing relating to, for example, the connection to a wireless access point and the update of an encryption key.

The main authentication unit 204 is an example of a first authentication unit.

For example, when the wireless LAN authentication method is WPA2-Enterprise using extensible authentication protocol transport layer security (EAP-TLS), the main authentication unit 204 verifies a server certificate using a CA certificate read from, for example, the RAM 112 and the ROM 113. Further, the main authentication unit 204 transmits a client certificate read from, for example, the RAM 112 and the ROM 113 and performs mutual authentication to generate a pre-shared key. Further, the main authentication unit 204 performs a four-way handshake using the generated pre-shared key, thereby completing the authentication processing. The four-way handshake is a procedure for exchanging encryption keys in, for example, a wireless LAN system.

The certificate management unit 205 stores electronic certificates such as the above-described CA certificate and client certificate in the RAM 112 and the ROM 113 and manages these electronic certificates. The communication control unit 206 is an interface used by the main authentication unit 204 to control the wireless LAN module 140 from the main system 110.

The storage unit 207 is implemented by, for example, a program executed by the CPU 111, the RAM 112, and the ROM 113. The storage unit 207 stores various data or various pieces of information such as the above-described electronic certificates, an encryption key such as a pre-shared key, and setting information for authentication methods in the RAM 112 and the ROM 113.

The power-saving control unit 208 is implemented by, for example, the power control circuit 114 and a program executed by the CPU 111. The power-saving control unit 208 causes the communication apparatus 100, which includes the main system 110, to shift to the power-saving mode at a predetermined timing. The predetermined timing refers to, for example, a timing after the main system 110 or the subsystem 120 executes the authentication processing for participating in the network 101 or a timing when an idle state has continued for a predetermined period of time or more. When the power control circuit 114 starts supplying power to the main system 110 in response to a return request signal transmitted from the subsystem 120, the power-saving control unit 208 may be activated prior to the other processing units and then activate the other processing units.

### Functional Configuration of Subsystem

The subsystem 120 includes, for example, a communication control unit 211, the event processing unit 212, a sub-response unit 213, a state control unit 214, and the sub-authentication unit 215, each of which is implemented by the CPU 121 reading and executing predetermined programs stored in the RAM 122 and the ROM 123. At least part of the above-described functional units may be implemented by hardware.

The communication control unit 211 is an interface used by the sub-authentication unit 215 to control the wireless LAN module 140 from the subsystem 120.

When the bus switching control device 130 uses the wireless LAN module connection bus 126 of the subsystem 120, the event processing unit 212 analyzes a data frame received by the wireless LAN module 140 and determines which processing unit (e.g., the sub-response unit 213, the sub-authentication unit 215, or the processing control unit 202) processes the data frame. The event processing unit 212 then transfers the received data frame to the determined processing unit. For example, when the communication apparatus 100 is in the normal mode, the event processing unit 212 transfers the received data frame to the processing control unit 202 of the main system 110. The data frame may also be referred to as a packet.

When the communication apparatus 100, which includes the main system 110, is in the power-saving mode, the event processing unit 212 determines whether or not the received data frame is processable by the subsystem 120. The details of the determination are described later. When the event processing unit 212 determines that the received data frame is not processable by the subsystem 120, the event processing unit 212 causes the communication apparatus 100, which includes the main system 110, to shift to the normal mode via the state control unit 214. After the event processing unit 212 causes the communication apparatus 100, which includes the main system 110, to shift to the normal mode, the event processing unit 212 transfers the received data frame to the processing control unit 202 of the main system 110.

When the main system 110 is in the power-saving mode and the event processing unit 212 determines that the received data frame is processable by the subsystem 120, the event processing unit 212 transfers the received data frame to the sub-authentication unit 215 or the sub-response unit 213, depending on the type of the received data frame. For example, when the type of the received data frame relates to the authentication processing, such as network connection processing or encryption-key updating processing, the event processing unit 212 transfers the received data frame to the sub-authentication unit 215. When the type of the received data frame relates to processing other than the authentication processing, the event processing unit 212 transfers the received data frame to the sub-response unit 213.

The sub-response unit 213 processes, within the subsystem 120, the data frame received from the event processing unit 212 and creates response data corresponding to the received data frame. The sub-response unit 213 also creates a data frame including the created response data and returns the created data frame to the event processing unit 212. In one example, the data frame processed by the sub-response unit 213 may include information that is storable in advance in the RAM 122 and the ROM 123, such as request data for inquiring a state, the apparatus name, the identification number, or a function of the communication apparatus 100. For example, the RAM 122 stores the state of the communication apparatus 100, and the ROM 123 stores the apparatus name, the identification number, or the function of the communication apparatus 100.

The state control unit 214 is, for example, implemented by the signal output circuit 124 and a program executed by the CPU 111. The state control unit 214 transmits a return request signal to the power-saving control unit 208 of the main system 110 under the control of the event processing unit 212 and causes the communication apparatus 100 to return (or shift) to the normal mode from the power-saving mode. The state control unit 214 transmits a signal (mode signal) indicating the current operation mode of the communication apparatus 100 to the bus switching control device 130.

The sub-authentication unit 215 executes second authentication processing using an authentication method that is executable within the subsystem 120. The second authentication processing includes processing relating to, for example, the connection to a wireless LAN access point or the update of an encryption key using, for example, the authentication method such as the open authentication or WPA2-PSK in which the processing relating to an electronic certificate is not executed.

The sub-authentication unit 215 is an example of a second authentication unit.

### First Embodiment

### Example of Configuration of Bus Switching Control Device

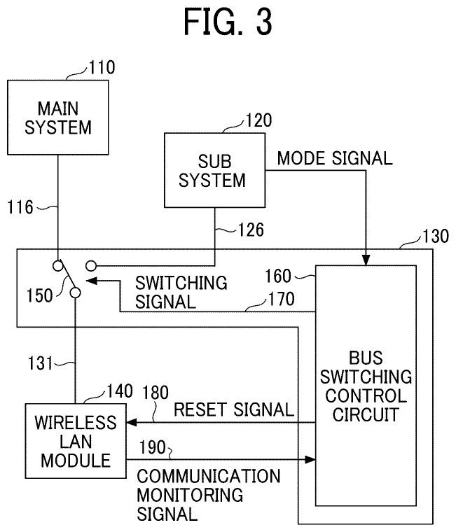

FIG. 3 is a block diagram schematically illustrating a configuration of a data communication system including the bus switching control device 130 according to the first embodiment.

With reference to FIG. 3, the bus switching control device 130, which is included in the communication apparatus 100 according to the present embodiment, includes a bus switch 150 and a bus switching control circuit 160. The bus switch 150 is connected to the main system 110, the subsystem 120, and the wireless LAN module 140, and establishes a connection with either one of the bus connected to the main system 110 or the bus connected to the subsystem 120. The bus switching control circuit 160 controls which bus the bus switch 150 is connected to. The bus switch 150 includes, for example, a simple switch and is easily disposed in the bus switching control device 130.

The bus switching control circuit 160 outputs a switching signal 170 to the bus switch 150 to switch the bus to which the bus switch 150 is connected. The bus switching control circuit 160 also outputs a reset signal 180 to the wireless LAN module 140 to reset the wireless LAN module 140, thereby establishing communication between the wireless LAN module 140 and the main system 110 or the subsystem 120 in an initial state. The bus switching control circuit 160 is, for example, hardware such as a CPU and executes information processing.

The wireless LAN module 140 outputs a communication monitoring signal 190 to the bus switching control circuit 160. The communication monitoring signal 190 is a signal (monitoring means) that allows the bus switching control circuit 160 to monitor communication between the wireless LAN module 140 and the main system 110 or the subsystem 120 connected to the wireless LAN module 140.

The bus switch 150 connects the main wireless LAN module control bus 116 and the wireless LAN module control bus 131 to each other to establish a connection between the main system 110 and the wireless LAN module 140. The bus switch 150 connects the wireless LAN module connection bus 126 and the wireless LAN module control bus 131 to each other to establish a connection between the subsystem 120 and the wireless LAN module 140.

In FIG. 3, the bus switching control circuit 160 receives the communication monitoring signal 190, thereby detecting that a bus that has established a connection with the wireless LAN module 140 is, for example, the main wireless LAN module control bus 116 connected to the main system 110 and also detecting the communication state between the wireless LAN module 140 and the main system 110.

The bus switch 150 and the bus switching control circuit 160 may be disposed separately from the main system 110 and the subsystem 120, as illustrated in FIG. 3. Alternatively, the main system 110 or the subsystem 120 may include the bus switch 150 and the bus switching control circuit 160.

### Processing Flow

A processing flow of a communication method according to the present embodiment is described below.

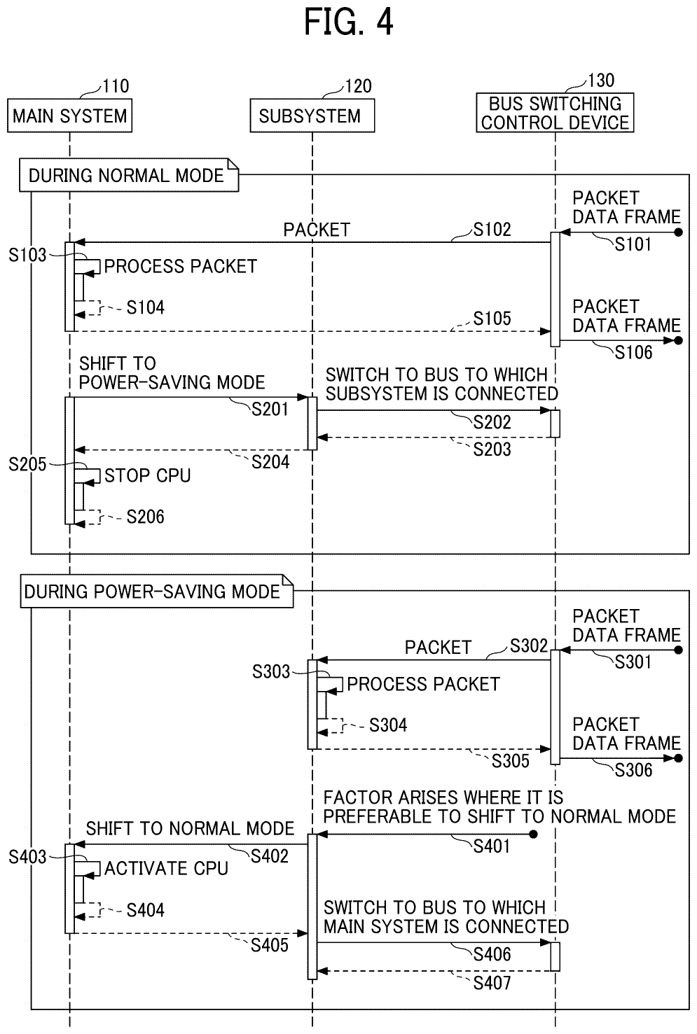

FIG. 4 is a sequence diagram illustrating the operation of the communication apparatus 100 in each operation mode according to the first embodiment.

The following describes the operation of the communication apparatus 100 when the communication apparatus 100 transmits and receives packet data frames while operating in the normal mode. Hereinafter, a packet data frame may be simply referred to as a data frame.

In step S101, the bus switching control device 130 receives a packet data frame via the wireless LAN module 140.

In step S102, the bus switching control device 130 directly transmits the received packet data frame to the main system 110. In step S103, the main system 110 processes the received packet data frame.

When the communication apparatus 100 is to transmit a packet data frame, the main system 110 processes, in step S104, the packet data frame to be transmitted.

In step S105, the main system 110 directly transmits the packet data frame, which is to be transmitted from the communication apparatus 100, to the bus switching control device 130.

In step S106, the wireless LAN module 140 transmits the packet data frame received from the bus switching control device 130.

In the present embodiment, after a packet data frame is received, another packet data frame is transmitted. However, the operation of the communication apparatus 100 is not limited thereto. In another embodiment, after a packet data frame is transmitted (steps S104 to S106), another packet data frame may be received (steps S101 to S103).

The following describes the operation of the communication apparatus 100 when the communication apparatus 100 shifts to the power-saving mode while operating in the normal mode. In step S201, the main system 110 issues a command (or request) to the subsystem 120 to cause the communication apparatus 100 to shift to the power-saving mode.

In step S202, the subsystem 120 transmits a mode signal indicating the power-saving mode to the bus switching control circuit 160 of the bus switching control device 130 according to the received command. In response, the bus switching control circuit 160 switches the bus to which the bus switch 150 is connected from the main wireless LAN module control bus 116 to the wireless LAN module connection bus 126, which is the bus for connecting to the subsystem 120. In step S202, the wireless LAN module 140 is also connected to the subsystem 120.

In step S203, the bus switching control device 130 transmits, to the subsystem 120, an acknowledgement (ACK) with respect to the mode signal received from the subsystem 120. Alternatively, for example, the bus switching control device 130 may transmit, to the subsystem 120, a signal indicating that the bus to which the bus switch 150 is connected has been switched from the main wireless LAN module control bus 116 to the wireless LAN module connection bus 126.

In step S204, the subsystem 120 transmits, to the main system 110, an ACK with respect to the command issued to cause the communication apparatus 100 to shift to the power-saving mode. Alternatively, the subsystem 120 may transmit, to the main system 110, a signal indicating that the bus to which the bus switch 150 is connected has been switched from the main wireless LAN module control bus 116 to the wireless LAN module connection bus 126.

In steps S205 and S206, the main system 110 stops the CPU 111 to cause the communication apparatus 100 to shift to the power-saving mode.

The above-described sequence is merely an example and the operation of the communication apparatus 100 is not limited thereto. For example, step S201 (a step for causing the communication apparatus 100 to shift to the power-saving mode) and step S202 (a step for switching the bus to be connected) may be executed simultaneously or in different order.

The following describes the operation of the communication apparatus 100 when the communication apparatus 100 transmits and receives packet data frames while operating in the power-saving mode.

In step S301, the bus switching control device 130 receives a packet data frame via the wireless LAN module 140.

In step S302, the bus switching control device 130 transmits the received packet data frame to the subsystem 120. In step S303, the subsystem 120 processes the received packet data frame.

When the communication apparatus 100 is to transmit a packet data frame, the subsystem 120 processes, in step S304, the packet data frame to be transmitted.

In step S305, the subsystem 120 transmits the packet data frame, which is to be transmitted from the communication apparatus 100, to the bus switching control device 130.

In step S306, the wireless LAN module 140 transmits the packet data frame received from the bus switching control device 130.

In the present embodiment, after a packet data frame is received, another packet data frame is transmitted. However, the operation of the communication apparatus 100 is not limited thereto. In another embodiment, after a packet data frame is transmitted (steps S304 to S306), another packet data frame may be received (steps S301 to S303).

The following describes the operation of the communication apparatus 100 when the communication apparatus 100 shifts to the normal mode while operating in the power-saving mode. In step S401, a factor arises where the communication apparatus 100 preferably shifts to the normal mode. Examples of the factor include receiving a packet data frame that is not processable by the subsystem 120. In this case, it is preferable that the packet data frame be processed by the main system 110.

In step S402, the subsystem 120 issues a command to the main system 110 to cause the communication apparatus 100 to shift to the normal mode.

In steps S403 and S404, the main system 110 activates the CPU 111 to cause the communication apparatus 100 to shift to the normal mode.

After the communication apparatus 100 shifts to the normal mode, the main system 110 transmits, for example, an ACK or a command to the subsystem 120 with respect to the command issued to cause the communication apparatus 100 to shift to the normal mode in step S405.

In step S406, the subsystem 120 controls the bus switching control device 130 according to, for example, the received ACK or command. The bus switching control circuit 160 switches the bus to which the bus switch 150 is connected to the main wireless LAN module control bus 116, which is the bus for connecting to the main system 110.

In step S407, the bus switching control device 130 transmits, to the subsystem 120, an ACK with respect to the command issued to cause the communication apparatus 100 to shift to the normal mode. Alternatively, the bus switching control device 130 may transmit, to the subsystem 120, a signal indicating that the bus to which the bus switch 150 is connected has been switched from the wireless LAN module connection bus 126 to the main wireless LAN module control bus 116.

The above-described sequence is merely an example and the operation of the communication apparatus 100 is not limited thereto. For example, step S402 (a step for causing the communication apparatus 100 to shift or return to the normal mode) and step S406 (a step for switching the bus to be connected) may be executed simultaneously or in different order.

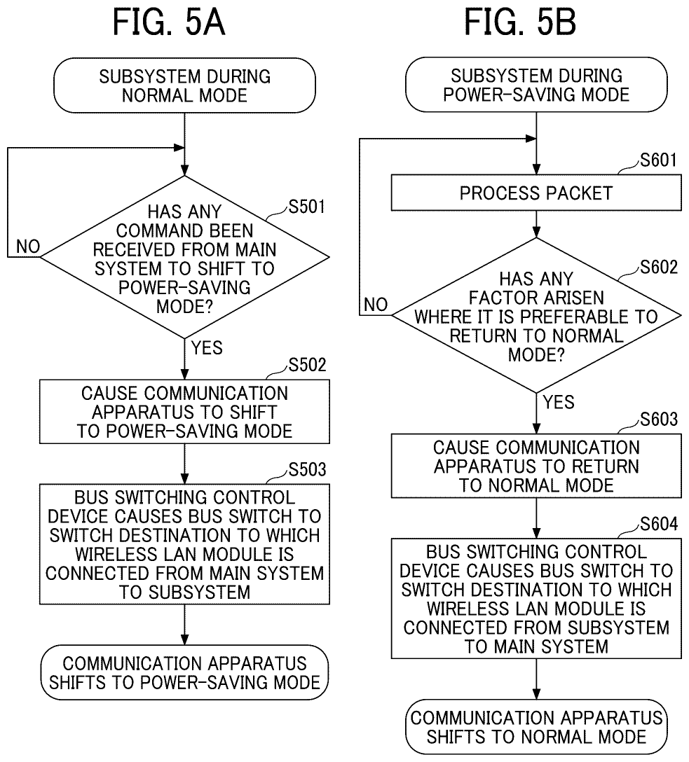

FIGS. 5A and 5B are flowcharts illustrating the operation of the subsystem 120 in different operation modes of the communication apparatus 100 according to the first embodiment.

The flowchart of the operation of the subsystem 120 in the normal mode is described below with reference to FIG. 5A. In step S501, the subsystem 120 determines whether or not to cause the bus switch 150 to switch the destination to which the wireless LAN module 140 is connected from the main system 110 to the subsystem 120 depending on whether or not the subsystem 120 has received, from the main system 110, a command to cause the communication apparatus 100 to shift to the power-saving mode.

For example, when the subsystem 120 has not received, from the main system 110, the command to cause the communication apparatus 100 to shift to the power-saving mode (NO in step S501), the communication apparatus 100 continues to operate in the normal mode and the bus switch 150 does not switch the destination to which the wireless LAN module 140 is connected. When the subsystem 120 has received, from the main system 110, the command to cause the communication apparatus 100 to shift to the power-saving mode (YES in step S501), the subsystem 120 causes the communication apparatus 100 to shift to the power-saving mode in step S502.

In step S502, the subsystem 120 causes the communication apparatus 100 to shift to the power-saving mode in response to the received command.

In step S503, the bus switching control device 130 causes the bus switch 150 to switch the destination to which the wireless LAN module 140 is connected from the main system 110 to the subsystem 120.

With the procedure described above, while the communication apparatus 100, which includes the subsystem 120, is in the normal mode, the communication apparatus 100 is switched from the normal mode to the power-saving mode.

The above-described flowchart is merely an example and the operation of the communication apparatus 100 is not limited thereto. For example, step S502 (a step for causing the communication apparatus 100 to shift to the power-saving mode) and step S503 (a step for switching the destination to be connected) may be executed simultaneously or in different order.

The flowchart of the operation of the subsystem 120 in the power-saving mode is described below with reference to FIG. 5B. In step S601, the subsystem 120 receives a packet from the wireless LAN module 140. The packet may also be referred to as packet data or a packet data frame.

In step S602, the subsystem 120 determines whether or not there is a factor where the communication apparatus 100 preferably returns to the normal mode. In other words, the subsystem 120 determines whether or not the received packet is processable by the subsystem 120. When the subsystem 120 determines that the received packet is processable by the subsystem 120 (i.e., when there is no factor where the communication apparatus 100 preferably returns to the normal mode), the communication apparatus 100 returns to step S601 and the subsystem 120 processes the received packet while the communication apparatus 100 maintains the power-saving mode. When the subsystem 120 determines that the received packet is not processable by the subsystem 120 (i.e., when there is a factor where the communication apparatus 100 preferably returns to the normal mode), the subsystem 120 proceeds to the step S603 described below.

When the subsystem 120 determines that there is a factor, the subsystem 120 causes the communication apparatus 100 to return to the normal mode in step S603.

After the subsystem 120 causes the communication apparatus 100 to return to the normal mode, the bus switching control device 130 causes the bus switch 150 to switch the destination to which the wireless LAN module 140 is connected from the subsystem 120 to the main system 110 in step S604.

With the procedure described above, while the communication apparatus 100, which includes the subsystem 120, is in the power-saving mode, the communication apparatus 100 shifts from the power-saving mode to the normal mode.

The above-described flowchart is merely an example and the operation of the communication apparatus 100 is not limited thereto. For example, step S603 (a step for causing the communication apparatus 100 to return to the normal mode) and step S604 (a step for switching the destination to be connected) may be executed simultaneously or in different order.

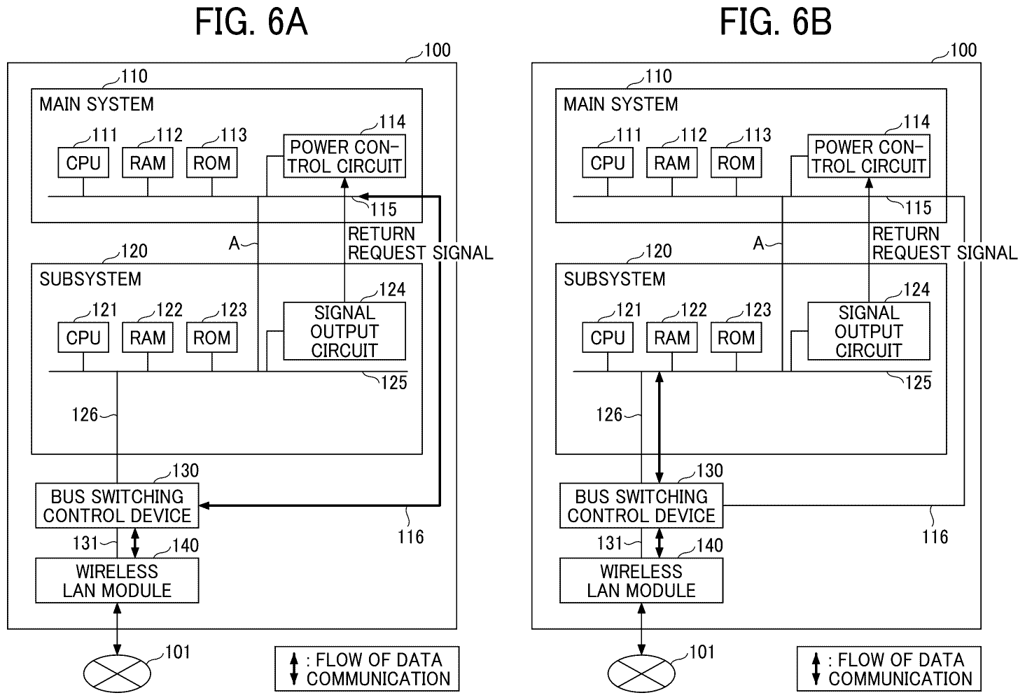

FIGS. 6A and 6B are diagrams illustrating flows of data communication of the communication apparatus 100 according to the first embodiment in different operation modes. Specifically, FIG. 6A illustrates a flow of data communication in the normal mode. FIG. 6B illustrates a flow of data communication in the power-saving mode.

In FIG. 6A, in the normal mode, the bus switching control device 130 allows the main system 110 to control the wireless LAN module 140 via the main wireless LAN module control bus 116. In order to maintain the wireless LAN connection after the communication apparatus 100 shifts from the normal mode to the power-saving mode, the subsystem 120 stores information to be used to maintain the wireless LAN connection. However, in the normal mode, the subsystem 120 does not execute processing relating to data communication.

The information to be used to maintain the wireless LAN connection may include, for example, authentication information relating to the wireless LAN communication.

According to the present embodiment, in the normal mode, the bus switching control device 130 allows the main system 110, which has a high information processing capacity, to directly control the wireless LAN module 140 without via the subsystem 120. With this configuration, the communication apparatus 100 achieves a high-speed wireless LAN communication compared to the case where the subsystem 120 executes processing relating to wireless LAN communication each time wireless LAN communication occurs.

In addition, in the normal mode illustrated in FIG. 6A, the main system 110 executes communication processing. In this case, the subsystem 120 does not determine the data frame received from the wireless LAN module 140.

In this way, according to the present embodiment, in the normal mode, the bus switching control device 130 performs control such that the main system 110 performs communication processing without via the subsystem 120. Since this configuration does not cause the subsystem 120 to determine a data frame, the wireless LAN communication is performed without reducing the communication speed.

The main wireless LAN module control bus 116 is an example of the first bus.

In FIG. 6B, in the power-saving mode, the bus switching control device 130 causes the subsystem 120 to control the wireless LAN module 140 via the wireless LAN module connection bus 126.

In this way, according to the present embodiment, in the power-saving mode, the bus switching control device 130 causes the subsystem 120 to control the wireless LAN module 140. With this configuration, in the system where the communication apparatus 100 performs switching such that the main system 110 directly controls the wireless LAN module 140, the communication apparatus 100 executes appropriate communication processing according to the power consumption mode set in the communication apparatus 100.

The wireless LAN module connection bus 126 is an example of the second bus.

### Second Embodiment

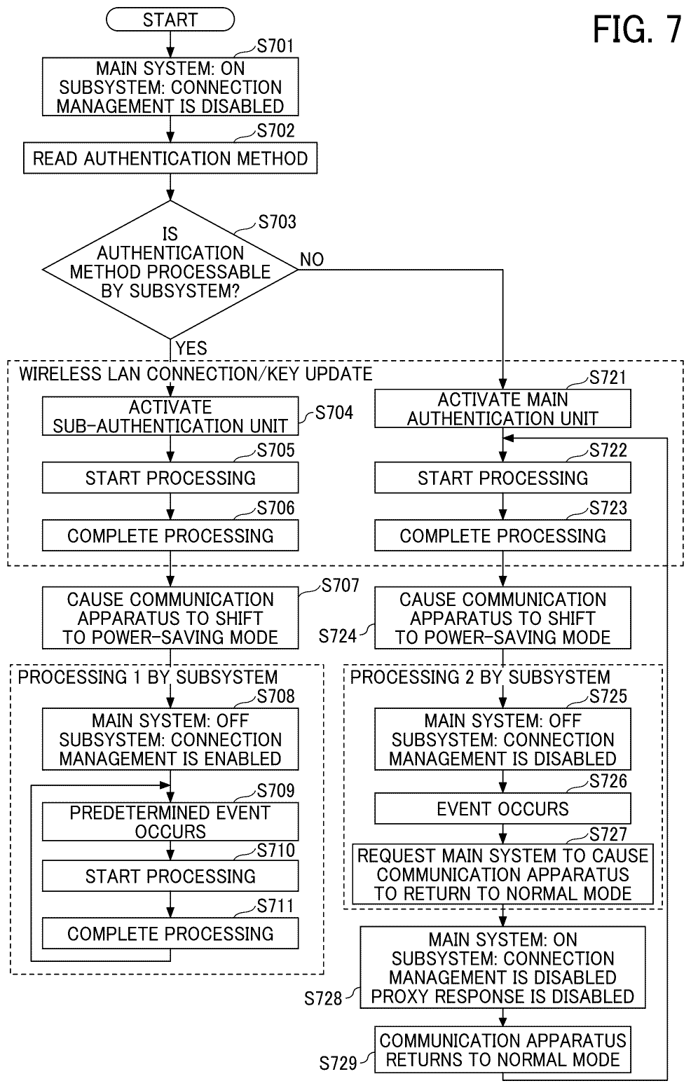

FIG. 7 is a flowchart illustrating an example of the processing of the communication apparatus 100 according to the second embodiment. Among various processing executed by the communication apparatus 100, the following description focuses on the processing relating to the authentication processing executed by the sub-authentication unit 215 and the main authentication unit 204.

In step S701, the main system 110 and the subsystem 120 are activated. At this time, the event processing unit 212 of the subsystem 120 disables the processing (connection management) executed by the sub-authentication unit 215. For example, the event processing unit 212 stores the connection management setting in the RAM 122 or the ROM 123.

In step S702, the authentication control unit 201 of the main system 110 reads, from the RAM 112 or the ROM 113, an authentication method set in the communication apparatus 100. In step S703, the authentication control unit 201 of the main system 110 determines whether or not the read authentication method is processable by the sub-authentication unit 215. For example, when the authentication method set in the communication apparatus 100 is an authentication method in which the processing relating to an electronic certificate is not executed, the authentication control unit 201 determines that the authentication method is processable by the subsystem 120. When the authentication method set in the communication apparatus 100 is an authentication method in which the processing relating to an electronic certificate is executed, the authentication control unit 201 determines that the authentication method is not processable by the subsystem 120. Examples of the authentication method in which the processing relating to an electronic certificate is not executed include open authentication and WPA2-PSK authentication. Examples of the authentication method in which the processing relating to an electronic certificate is executed include WPA2-Enterprise authentication.

When the authentication control unit 201 determines that the authentication method is processable by the subsystem 120 (YES in step S704), the authentication control unit 201 causes the processing to proceed to step S704. When the authentication control unit 201 determines that the authentication method is not processable by the subsystem 120 (NO in step S704), the authentication control unit 201 causes the processing to proceed to step S721. In step S704, the authentication control unit 201 of the main system 110 activates the sub-authentication unit 215 of the subsystem 120. At this time, the authentication control unit 201 sets a passphrase read from the RAM 112 or the ROM 113 to the sub-authentication unit 215. The passphrase is used to generate a pre-shared key. The passphrase includes, for example, a combination of characters and numbers. For example, the passphrase may be a password of 10 characters and numbers or less. The passphrase is, for example, set by a user or an administrator and stored in the RAM 112 or the ROM 113.

In step S705, the sub-authentication unit 215 of the subsystem 120 starts the authentication processing for participating in (or connecting to) the network 101. At this time, the sub-authentication unit 215 processes a data frame for key exchange corresponding to the authentication method or an event specific to the wireless LAN. For example, when the authentication method is WPA2-PSK, the sub-authentication unit 215 generates a pre-shared key based on the passphrase set by the authentication control unit 201 and performs a four-way handshake. Participating in (or connecting to) the network 101 includes, for example, a wireless connection to an external access point.

In step S706, when the sub-authentication unit 215 has completed the authentication processing, the power-saving control unit 208 of the main system 110 causes the communication apparatus 100, which includes the main system 110, to shift to the power-saving mode in step S707. After the communication apparatus 100 shifts to the power-saving mode, the subsystem 120 executes processing 1 in steps S708 to S711.

In step S708, the main system 110 is turned off. In other words, the communication apparatus 100 is in the power-saving mode. At this time, the event processing unit 212 of the subsystem 120 enables processing (or connection management) by the sub-authentication unit 215.

When a predetermined event relating to a connection to the network 101 occurs and the occurrence of the predetermined event is detected at the event processing unit 212 in step S709, the event processing unit 212 starts processing the predetermined event so as to complete the processing within the subsystem 120 without causing the communication apparatus 100 to shift to the normal mode in step S710. For example, when the wireless LAN module 140 receives a data frame for key exchange, the event processing unit 212 transfers the received data frame to the sub-authentication unit 215. The reception of a data frame for key exchange is an example of the predetermined event.

When the sub-authentication unit 215 receives the data frame for key exchange from the event processing unit 212, the sub-authentication unit 215 executes processing for updating an encryption key.

In step S711, when the sub-authentication unit 215 has completed the processing, the event processing unit 212 causes the processing to return to step S709 and waits for the occurrence of a predetermined event.

In this way, according to the present embodiment, when the authentication method set in the communication apparatus 100 is an authentication method such as an open authentication or WPA2-PSK authentication in which the processing relating to an electronic certificate is not executed, the communication apparatus 100 processes a predetermined event, such as the updating of an encryption key, within the subsystem 120.

When the processing proceeds from step S703 to step S721, the authentication control unit 201 of the main system 110 activates the main authentication unit 204 of the main system 110.

In step S722, the main authentication unit 204 of the main system 110 starts the authentication processing for participating in (or connecting to) the network 101. At this time, the main authentication unit 204 processes a data frame for key exchange corresponding to the authentication method or an event specific to the wireless LAN. For example, when the authentication method is WPA2-Enterprise using EAP-TLS, the main authentication unit 204 verifies a server certificate using a CA certificate read from the RAM 112 or the ROM 113. Further, the main authentication unit 204 transmits a client certificate read from, for example, the RAM 112 and the ROM 113 and performs mutual authentication to generate a pre-shared key. Further, the main authentication unit 204 performs a four-way handshake using the generated pre-shared key. Participating in (or connecting to) the network 101 includes, for example, a wireless connection to an external access point.

In step S723, when the main authentication unit 204 has completed the authentication processing, the power-saving control unit 208 of the main system 110 causes the communication apparatus 100, which includes the main system 110, to shift to the power-saving mode in step S724. After the communication apparatus 100 shifts to the power-saving mode, the subsystem 120 executes processing 2 in steps S725 to S727.

In step S725, the main system 110 is turned off. In other words, the communication apparatus 100 is in the power-saving mode. At this time, the event processing unit 212 of the subsystem 120 maintains the state in which the processing (or connection management) by the sub-authentication unit 215 is disabled.

When a predetermined event relating to a connection to the network 101 occurs and the occurrence of the predetermined event is detected at the event processing unit 212 in step S726, the event processing unit 212 requests the main system 110, via the state control unit 214, to cause the communication apparatus 100 to return to the normal mode in step S727.

In step S728, the main system 110 is turned on. In other words, the communication apparatus 100 is in the normal mode. At this time, the event processing unit 212 of the subsystem 120 maintains the state in which the processing (or connection management) by the sub-authentication unit 215 is disabled. Preferably, the event processing unit 212 sets the processing (or a proxy response) by the sub-response unit 213 to be disabled. For example, the event processing unit 212 stores the setting of the proxy response in the RAM 122 or the ROM 123.

After the communication apparatus 100, which includes the main system 110, returns to the normal mode in step S729, the main system 110 causes the processing to proceed to step S722. For example, the event processing unit 212 of the subsystem 120 transfers a data frame for key exchange received by the wireless LAN module 140 to the main authentication unit 204 via the processing control unit 202 of the main system 110.

In this case, in step S722, the main authentication unit 204 of the main system 110 executes processing for updating an encryption key according to the data frame for key exchange received from the processing control unit 202.

In this way, according to the present embodiment, when the authentication method set in the communication apparatus 100 is an authentication method such as WPA2-Enterprise using EAP-TLS in which the processing relating to an electronic certificate is executed, the communication apparatus 100 executes the processing using the main system 110. The first authentication processing, which is executed by the main system 110 and involves the processing relating to an electronic certificate, is an example of a predetermined function that is executable by the communication apparatus 100 in the normal mode.

According to the embodiments of the present disclosure, when the communication apparatus 100, which includes the main system 110 and the subsystem 120, is in the normal mode, the bus switching control device 130 performs control such that the main system 110 performs communicating processing without using the subsystem 120. This configuration ensures that the wireless LAN communication is performed without reducing the communication speed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

Aspects of the present disclosure are, for example, as follows.

According to Aspect 1, a communication apparatus that operates in a plurality of operation modes with different power consumptions includes a main system, a subsystem, a communication module, a first bus, a second bus, a bus switch, and a bus switching control circuit. The communication module communicates with an external apparatus. The first bus connects the main system and the communication module to each other to allow the main system to control the communication module. The second bus connects the subsystem and the communication module to each other to allow the subsystem to control the communication module. The bus switch switches between two states. One of the two states is a state in which the main system and the communication module are communicably connected to each other via the first bus. Another one of the two states is a state in which the subsystem and the communication module are communicably connected to each other via the second bus. The bus switching control circuit controls the bus switch to switch between the two states according to an operation mode set in the communication apparatus among the plurality of operation modes.

According to Aspect 2, in the communication apparatus of Aspect 1, the plurality of operation modes with the different power consumptions includes a normal mode in which the main system operates, and a power-saving mode in which the main system stops and the subsystem operates.

According to Aspect 3, in the communication apparatus of Aspect 2, the subsystem includes a sub-authentication unit and an event processing unit. When an authentication method for communication read by the main system includes authentication processing executable by the subsystem, the sub-authentication unit controls the subsystem such that the subsystem executes the authentication processing. When a predetermined event relating to connection of the communication occurs after the subsystem completes the authentication processing and the operation mode shifts to the power-saving mode, the event processing unit controls the subsystem such that the subsystem processes the predetermined event.

According to Aspect 4, in the communication apparatus of Aspect 2 or 3, when the operation mode shifts from the normal mode to the power-saving mode, the bus switching control circuit controls the bus switch such that the subsystem and the communication module are communicably connected to each other via the second bus.

According to Aspect 5, in the communication apparatus of Aspect 2 or 3, when the operation mode shifts from the power-saving mode to the normal mode, the bus switching control circuit controls the bus switch such that the main system and the communication module are communicably connected to each other via the first bus.

According to Aspect 6, in the communication apparatus of any one of Aspects 1 to 5, the bus switching control circuit receives, from the subsystem, a signal indicating the operation mode and transmits, to the bus switch, a signal to cause the bus switch to switch between the two states according to the operation mode indicated by the received signal.

According to Aspect 7, in the communication apparatus of any one of Aspects 1 to 6, the communication module and the bus switch are disposed separately from the main system and the subsystem.

According to Aspect 8, a communication method executed by a communication apparatus that includes a main system and a subsystem and operates in a plurality of operation modes with different power consumptions includes connecting the main system and a communication module to each other via a first bus to allow the main system to control the communication module, the communication module being a communication module to communicate with an external apparatus, connecting the subsystem and the communication module to each other via a second bus to allow the subsystem to control the communication module, switching between two states, one of the two states being a state in which the main system and the communication module are communicably connected to each other via the first bus, another one of the two states being a state in which the subsystem and the communication module are communicably connected to each other via the second bus, and controlling the switching between the two states according to an operation mode set in the communication apparatus among the plurality of operation modes.

According to Aspect 9, a non-transitory recording medium stores a plurality of instructions which, when executed by one or more processors, causes the processors to perform the communication method described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A communication apparatus that operates in a plurality of operation modes with different power consumptions, the communication apparatus comprising:
a main system;
a subsystem;
a communication module to communicate with an external apparatus external to the communication apparatus;
a first bus to connect the main system and the communication module to each other to allow the main system to control the communication module;
a second bus to connect the subsystem and the communication module to each other to allow the subsystem to control the communication module;
a bus switch to switch between two states, one of the two states being a state in which the main system and the communication module are communicably connected to each other via the first bus, another one of the two states being a state in which the subsystem and the communication module are communicably connected to each other via the second bus; and
a bus switching control circuit configured to control the bus switch to switch between the two states according to an operation mode set in the communication apparatus among the plurality of operation modes.

2. The communication apparatus according to claim 1, wherein the plurality of operation modes with the different power consumptions includes:
a normal mode in which the main system operates; and
a power-saving mode in which the main system stops and the subsystem operates.

3. The communication apparatus according to claim 2, wherein the subsystem includes circuitry configured to:
when an authentication method for communication read by the main system includes authentication processing executable by the subsystem, control the subsystem to execute the authentication processing; and
when a predetermined event relating to connection of the communication is detected after the operation mode shifts to the power-saving mode in response to completion of the authentication processing by the subsystem, control the subsystem to process the predetermined event.

4. The communication apparatus according to claim 2, wherein, when the operation mode shifts from the normal mode to the power-saving mode, the bus switching control circuit is configured to control the bus switch such that the subsystem and the communication module are communicably connected to each other via the second bus.

5. The communication apparatus according to claim 2, wherein, when the operation mode shifts from the power-saving mode to the normal mode, the bus switching control circuit is configured to control the bus switch such that the main system and the communication module are communicably connected to each other via the first bus.

6. The communication apparatus according to claim 1, wherein the bus switching control circuit is configured to receive, from the subsystem, a signal indicating the operation mode and transmit, to the bus switch, a signal to cause the bus switch to switch between the two states according to the operation mode indicated by the received signal.

7. The communication apparatus according to claim 1, wherein the communication module and the bus switch are separate from the main system and the subsystem.

8. A communication method executed by a communication apparatus that includes a main system and a subsystem and operates in a plurality of operation modes with different power consumptions, the communication method comprising:
connecting the main system and a communication module to each other via a first bus to allow the main system to control the communication module, the communication module being a communication module to communicate with an external apparatus external to the communication apparatus;
connecting the subsystem and the communication module to each other via a second bus to allow the subsystem to control the communication module; and
controlling a bus switch to switch between two states according to an operation mode set in the communication apparatus among the plurality of operation modes, one of the two states being a state in which the main system and the communication module are communicably connected to each other via the first bus, another one of the two states being a state in which the subsystem and the communication module are communicably connected to each other via the second bus.

9. The communication method according to claim 8, wherein the plurality of operation modes with the different power consumptions includes:
a normal mode in which the main system operates; and
a power-saving mode in which the main system stops and the subsystem operates.

10. The communication method according to claim 9, further comprising:
when an authentication method for communication read by the main system includes authentication processing executable by the subsystem, controlling the subsystem to execute the authentication processing; and
when a predetermined event relating to connection of the communication is detected after the operation mode shifts to the power-saving mode in response to completion of the authentication processing by the subsystem, controlling the subsystem to process the predetermined event.

11. The communication method according to claim 9, further comprising:
when the operation mode shifts from the normal mode to the power-saving mode, controlling the bus switch such that the subsystem and the communication module are communicably connected to each other via the second bus.

12. The communication method according to claim 9, further comprising:
when the operation mode shifts from the power-saving mode to the normal mode, controlling the bus switch such that the main system and the communication module are communicably connected to each other via the first bus.

13. The communication apparatus according to claim 8, further comprising:
in response to receiving a signal indicating the operation mode from the subsystem, transmitting, to the bus switch, a signal to cause the bus switch to switch between the two states according to the operation mode indicated by the received signal.

14. A non-transitory recording medium storing a plurality of instructions which, when executed by one or more processors on a communication apparatus, causes the processors to perform a communication method, the communication apparatus including a main system and a subsystem and configured to operate in a plurality of operation modes with different power consumptions, the communication method comprising:
connecting the main system and a communication module to each other via a first bus to allow the main system to control the communication module, the communication module being a communication module to communicate with an external apparatus external to the communication apparatus;
connecting the subsystem and the communication module to each other via a second bus to allow the subsystem to control the communication module; and
controlling a bus switch to switch between two states according to an operation mode set in the communication apparatus among the plurality of operation modes, one of the two states being a state in which the main system and the communication module are communicably connected to each other via the first bus, another one of the two states being a state in which the subsystem and the communication module are communicably connected to each other via the second bus.
